(19) United States
(12) Patent Application Publication
(10) Pub. No.: US 2014/0263768 A1
(43) Pub. Date: Sep. 18, 2014

(54) MECHANICAL GRINDING MILL, TONER MANUFACTURING DEVICE AND TONER MANUFACTURING METHOD

(71) Applicant: Kohji Noge, Shizuoka (JP)

(72) Inventor: Kohji Noge, Shizuoka (JP)

(73) Assignee: RICOH COMPANY, LTD., Tokyo (JP)

(21) Appl. No.: 14/194,895

(22) Filed: Mar. 3, 2014

(30) Foreign Application Priority Data
Mar. 15, 2013 (JP) 2013-053782

(51) Int. Cl. B02C 17/18; B02C 25/00

(52) U.S. Cl. CPC B02C 17/1815; B02C 25/00
USPC 241/23; 241/67

(57) ABSTRACT

In a horizontal-type mechanical grinding mill in which a rotor is arranged in a stator, the axial direction of the rotor is the horizontal direction, a rotor cooling water inlet from which cooling water is brought into a rotor cooling water flow passage of the rotor is provided in the rotor on the side of a ground item discharge port in the axial direction, and a rotor cooling water outlet from which the cooling water comes out after passing through the rotor cooling water flow passage is provided in the rotor on the side of an item-to-be-ground supply port in the axial direction.

### CROSS-REFERENCE TO RELATED APPLICATIONS

This patent application is based on and claims priority pursuant to 35 U.S.C. §119 to Japanese Patent Application No. 2013-053782, filed on Mar. 15, 2013 in the Japan Patent Office, the entire disclosure of which is hereby incorporated by reference herein.

### BACKGROUND OF THE INVENTION

1. Field of the Invention

The present invention relates to a mechanical grinding device for grinding items to be ground such as toner materials to obtain ground items, and a toner manufacturing device and a toner manufacturing method of the toner using this mechanical grinding device.

2. Description of the Related Art

In an electrophotographic type image forming method, a toner for developing an electrostatic charge image is used. A toner and colored resin powder for developing an electrostatic charge image in electrophotography or the like are made of at least binder resin and a coloring agent. In general, the toner and the colored resin powder are adjusted to have predetermined grain size by melting and kneading a mixture containing material thereof by a kneading machine, cooling and solidifying, and grinding and classifying this cooled item. Nowadays, a step of adding an additive agent to the toner and the colored resin powder already adjusted to have predetermined grain size is provided for the purpose of improvement of fluidity index or the like, to thereby various characteristic values are improved.

As a grinding device used in the above grinding step of grinding the cooled item, there is known a mechanical grinding device in which a columnar rotor is arranged inside a cylindrical stator and the rotor is rotated.

In this mechanical grinding device, a gap between an inner wall surface of the stator and an outer wall surface of the rotor serves as a grinding chamber in which items to be ground are ground, and by rotating the rotor, the items to be ground collide with the rotor and the stator and collide with each other, to thereby the items to be ground are ground and ground items are obtained.

Also, an item-to-be-ground supply port for supplying the items to be ground to the grinding chamber is provided in one end of an axial direction parallel to the rotation axis of the rotor in the stator, and a ground item discharge port for discharging the ground items from the grinding chamber is provided in the other end of the axial direction. The items to be ground supplied from the item-to-be-ground supply port to the grinding chamber are moved toward the ground item discharge port in the axial direction while being moved in a rotation direction.

The items to be ground passing through the mechanical grinding device are heated by heat generated by collision energy at the time of collision or heat generated by friction. Thus, in a case of grinding items to be ground which may have troubles at a high temperature such as toner materials, there is a need for cooling down the items to be ground in the grinding chamber.

Unexamined Japanese Patent Application Publication No. JP-2004-042029-A, Unexamined Japanese Patent Application Publication No. JP-2009-011959-A, and Unexamined Japanese Patent Application Publication No. JP-2009-262003-A describe mechanical grinding devices in which a cooling water flow passage through which cooling water passes is provided in a rotor and the cooling water flows in the rotor.

Unexamined Japanese Patent Application Publication No. JP-2004-042029-A describes a mechanical grinding device in which the axial direction is the vertical direction. FIG. 1 thereof shows a configuration in which cooling water passes through a cooling water flow passage in a rotor from a cooling water inlet provided in an upper end of the rotor in the vertical direction toward a cooling water outlet provided in a lower end in the vertical direction. FIG. 3 shows a configuration in which the cooling water inlet and the cooling water outlet are provided in the upper end of the rotor in the vertical direction and the cooling water flow passage loops back at the lower end of the rotor.

Unexamined Japanese Patent Application Publication No. JP-2009-011959-A and Unexamined Japanese Patent Application Publication No. JP-2009-262003-A describe mechanical grinding devices in which the axial direction is the horizontal direction, a cooling water inlet is provided in one end of the rotor in the axial direction, and a cooling water outlet is provided in the other end.

In a case of the configuration in which the cooling water passes through from the upper end of the rotor toward the lower end as in FIG. 1 of Unexamined Japanese Patent Application Publication No. JP-2004-042029-A, even when the cooling water flow passage in the rotor is not filled with the cooling water, the cooling water flowing in from the cooling water inlet flows downward due to gravitational force and flows out from the cooling water outlet. In a state where the cooling water flow passage is not filled with the cooling water, efficient heat movement to the cooling water is deteriorated, and items to be ground cannot be efficiently cooled down.

With the configuration in which the cooling water inlet and the cooling water outlet are provided in the upper end of the rotor as in FIG. 3 of Unexamined Japanese Patent Application Publication No. JP-2004-042029-A, the cooling water flow passage can be filled with the cooling water. However, a flow passage of cooling water flowing into the cooling water flow passage from the cooling water inlet in which the cooling water have a low temperature before contributing to cooling of the items to be ground is close to a flow passage of cooling water flowing toward the cooling water outlet in which the cooling water have an increased temperature after contributing to cooling of the items to be ground. Therefore, the cooling water flowing into the cooling water flow passage unexpectedly contributes to cooling of the cooling water having the increased temperature before cooling down the items to be ground. Thus, the items to be ground cannot be efficiently cooled down.

With the configurations described in Unexamined Japanese Patent Application Publication No. JP-2009-011959-A and Unexamined Japanese Patent Application Publication No. JP-2009-262003-A, in order to let cooling water pass through from the one end in the horizontal direction to the other end, the cooling water flows in by exerting pressure thereto. Thus, a cooling water flow passage can be filled with the cooling water. In addition, since the cooling water inlet provided in the one end in the axial direction is away from the cooling water outlet provided in the other end, the cooling water flowing into the cooling water flow passage does not unexpectedly contribute to cooling of cooling water having an increased temperature before cooling items to be ground.

However, with the configurations described in Unexamined Japanese Patent Application Publication No. JP-2009-011959-A and Unexamined Japanese Patent Application Publication No. JP-2009-262003-A, the cooling water inlet is provided on the side of an item-to-be-ground supply port in the axial direction, and the cooling water outlet is provided on the side of a ground item discharge port. The items to be ground are heated while passing through a grinding chamber of the mechanical grinding device, and a temperature is gradually increased even when the cooling is performed, and the temperature becomes higher on the side of the ground item discharge port. At this time, when the cooling water outlet is provided on the side of the ground item discharge port, the items to be ground in the vicinity of the ground item discharge port are cooled down by the cooling water having the increased temperature after contributing to cooling. Thus, a problem arises that the items to be ground cannot be efficiently cooled down.

### SUMMARY OF THE INVENTION

The present invention is made in consideration with the above problems, and an object thereof is as follows. That is, the present invention provides a mechanical grinding device including a rotor to be rotated in a stator in which cooling water passes through the rotor, the mechanical grinding device being capable of cooling down an item to be ground more efficiently than the conventional example, and a toner manufacturing device and a toner manufacturing method in which this mechanical grinding device is used.

In order to achieve the above object, a first aspect according to claim 1 is a mechanical grinding device including a cylindrical stator, a columnar rotor arranged inside the stator in such a manner that the center axis overlies the center axis of the stator, the rotor being rotatable about the center axis, a grinding chamber formed in a gap between an inner peripheral surface of the stator and an outer peripheral surface of the rotor, and configured to have an inside through which an item to be ground passes, to thereby the item to be ground is ground by rotating the rotor, an item-to-be-ground supply port for supplying the item to be ground to the grinding chamber, the item-to-be-ground supply port being provided in one end in the axial direction parallel to the center axis in the grinding chamber, a ground item discharge port for discharging a ground item obtained by grinding the item to be ground, the ground item discharge port being provided in the other end in the axial direction in the grinding chamber and provided, and a cooling water supplying unit for supplying cooling water to a cooling water flow passage provided inside the rotor, wherein the axial direction is the horizontal direction, a cooling water inlet from which the cooling water is brought into the cooling water flow passage is provided in the rotor on the side of the ground item discharge port in the axial direction, and a cooling water outlet from which the cooling water comes out after passing through the cooling water flow passage is provided in the rotor on the side of the item-to-be-ground supply port in the axial direction.

In the present invention, since the axial direction is the horizontal direction and the cooling water passes through from the one end in the horizontal direction to the other end, the cooling water flow passage can be filled with the cooling water. Therefore, in comparison to the configuration in which the cooling water can flow out from the cooling water outlet even when the cooling water flow passage is not filled with the cooling water, the item to be ground can be efficiently cooled down.

In addition, the cooling water inlet is provided in the rotor on the side of the ground item discharge port in the axial direction, and the cooling water outlet is provided in the rotor on the side of the item-to-be-ground port in the axial direction. Thereby, the cooling water passes through from the one end side in the axial direction to the other end side. Thus, the cooling water flowing into the cooling water flow passage does not contribute to cooling of cooling water having an increased temperature before cooling the item to be ground. Therefore, in comparison to the configuration in which the cooling water inlet and the cooling water outlet are provided on the one end side in the axial direction, the item to be ground can be efficiently cooled down.

Further, since the cooling water inlet is provided on the side of the ground item discharge port, the item to be ground having a relatively high temperature in the vicinity of the ground item discharge port can be cooled down by a cooling liquid having a low temperature before contributing to cooling. Therefore, in comparison to the configuration in which the cooling water outlet is provided on the side of the ground item discharge port, the item to be ground can be efficiently cooled down.

The present invention provides an excellent effect that the item to be ground can be cooled down more efficiently than the conventional example.

### BRIEF DESCRIPTION OF THE SEVERAL VIEWS OF THE DRAWINGS

FIG. 1 is an enlarged illustrative view of a horizontal-type mechanical grinding mill according to the present embodiment;

FIG. 2 is an illustrative view of a toner manufacturing device 500 in which the horizontal-type mechanical grinding mill according to the present embodiment is used;

FIG. 3 is an illustrative view schematically showing a state where items to be ground are ground by the horizontal-type mechanical grinding mill;

FIG. 4 is an enlarged view of a section orthogonal to the rotation center axis E of a rotor and a stator; and

FIG. 5 is an enlarged perspective view of an outer peripheral surface of the rotor.

### DETAILED DESCRIPTION OF THE INVENTION

An embodiment of a grinding device to which the present invention is applied will be described below.

FIG. 2 is an illustrative view of a toner manufacturing device 500 using a horizontal-type mechanical grinding mill 100 serving as the grinding device to which the present invention is applied.

Three devices including a first temperature controller 1, a dehumidifier 2, and a second temperature controller 3 in FIG. 2 are referred to as cool blast generation devices, and those manufactured by Munters can be used as the cool blast generation devices.

In the horizontal-type mechanical grinding mill 100, materials before being supplied to the horizontal-type mechanical grinding mill 100 and materials placed at a position to be ground in the horizontal-type mechanical grinding mill 100 are referred to as items to be ground D1, and materials already ground and discharged from the horizontal-type mechanical grinding mill 100 are referred to as ground items D2.

In the first temperature controller 1, a temperature of the atmospheric pressure air suctioned from the external air is increased to be a dehumidifiable temperature. In the dehumidifier 2, the air whose temperature is increased in the first temperature controller 1 passes through a honeycomb rotor where water content is absorbed so that the dry air is generated. The second temperature controller 3 cools the air dried in the dehumidifier 2 down to −10[° C.] to −20[° C.], and supplies a necessary volume of the air to the horizontal-type mechanical grinding mill 100.

An item-to-be-ground container 4 supplies toner materials serving as the items to be ground D1 from an item-to-be-ground container (not shown) to an airstream sent from the second temperature controller 3 toward the horizontal-type mechanical grinding mill 100.

In a setting chamber 5, foreign substances (iron balls of φ1 [mm] or more) mixed into the toner materials are removed.

A brine chiller 200 is a device for cooling down brine which serves as cooling water to be supplied to the horizontal-type mechanical grinding mill 100, and controlling a temperature of the brine to a suitable temperature for cooling in the horizontal-type mechanical grinding mill 100.

A cyclone 6 separates the exhaust air containing the toner materials ground through the horizontal-type mechanical grinding mill 100 to make ground items D2 into a solid part and a gas part, and transports the toner materials to be a product to a next step.

A bag filter 7 separates fine particles from gas part which is separated from a solid part in the cyclone 6.

A blower 8 is a fan for suctioning in vacuum (about −30 [kPa]) in a toner grinding step.

FIG. 1 is an enlarged illustrative view of the horizontal-type mechanical grinding mill 100 according to the present embodiment.

The horizontal-type mechanical grinding mill 100 includes a columnar rotor 110, and a cylindrical fixed stator 120 (also referred to as “liner”), and a grinding chamber 150 is formed between an outer peripheral surface of the rotor 110 and an inner peripheral surface of the stator 120.

FIG. 3 is an illustrative view schematically showing a state where the items to be ground D1 are ground by the horizontal-type mechanical grinding mill 100. The rotor 110 of the horizontal-type mechanical grinding mill 100 is rotated about the rotation center axis E shown by one chain line in FIGS. 1 and 3 in an arrow C direction in the figures.

FIG. 4 is an enlarged view of a section orthogonal to the rotation center axis E of the rotor 110 and the stator 120, and also serves as an illustrative view showing a state where the items to be ground D1 in the grinding chamber 150 collide with the rotor 110 and the stator 120. FIG. 5 is an enlarged perspective view of the outer peripheral surface of the rotor 110 seen from an end in the axial direction parallel to the X axis in FIGS. 1 and 3, which shows grinding teeth 110a formed on the outer peripheral surface of the rotor 110.

Also, as shown in FIGS. 3 to 5, concave and convex parts parallel to the axial direction are formed on the outer peripheral surface of the rotor 110 continuously in the circumferential direction. As shown in FIG. 4, concave and convex parts parallel to the axial direction are also formed on the inner peripheral surface of the stator 120 continuously in the circumferential direction.

As shown in FIGS. 4 and 5, bottoms of the concave parts among the concave and convex parts on the outer peripheral surface of the rotor 110 and the inner peripheral surface of the stator 120 are formed in a round shape.

In the horizontal-type mechanical grinding mill 100, the toner materials serving as the items to be ground D1 are supplied from an item-to-be-ground supply port 130, and the toner materials turned into the ground items D2 are discharged from a ground item discharge port 140.

The rotor 110 is a water cooling-type rotor for performing high speed rotation, and includes a rotor cooling water flow passage 118 therein.

The X axis direction in the figures is the horizontal direction, the Z axis direction is the vertical direction, and the rotation center axis E parallel to the X axis in the figures extends in the horizontal direction. Therefore, the toner materials supplied form the item-to-be-ground supply port 130 are ground while being moved in the horizontal direction, that is, in the lateral direction, and discharged from the ground item discharge port 140.

The rotor 110 has end plates (a discharge-side end plate 116 and a supply-side end plate 117) at each of the both ends in the axial direction. These end plates are disc-shape members for fixing both of the ends in the axial direction of the rotor 110. A shaft 115 is a shaft of the rotor 110 rotated at high speed, and equipped with a mechanism for supplying the cooling water to the rotor cooing water flow passage 118 from outside.

A cooling water supply-side rotary joint 113 is a coupling for sending the cooling water into the shaft 115 which rotates at high speed from an external fixed pipe. A cooling water discharge-side rotary joint 114 is a coupling for sending the cooling water to the external fixed pipe from the shaft 115 which rotates at high speed.

The cooling water supplied from the brine chiller 200 into the rotor 110 flows into a flow passage in the cooling water supply-side rotary joint 113 from a rotor cooling water inlet 111, and then passes through an inlet-side intra-shaft flow passage 215a in the shaft 115. After that, the cooling water passes through an intra-discharge-side end plate flow passage 216 in the discharge-side end plate 116, flows into the rotor cooling water flow passage 118 in the rotor 110, and passes through the rotor cooling water flow passage 118 from the side of the ground item discharge port 140 toward the side of the item-to-be-ground supply port 130. The cooling water passing through the rotor cooling water flow passage 118 passes through an intra-supply-side end plate flow passage 217 in the supply-side end plate 117, and flows into an outlet-side intra-shaft flow passage 215b in the shaft 115. The cooling water which have passed through the outlet-side intra-shaft flow passage 215b passes through the cooling water discharge-side rotary joint 114, is discharged from a rotor cooling water outlet 112, and is returned to the brine chiller 200 through an external pipe.

In a joint between the rotor 110 and the discharge-side end plate 116, a rubber O ring (not shown) is arranged in order to prevent the cooling water from leaking out between the intra-discharge-side end plate flow passage 216 and the rotor cooling water flow passage 118. Also, in a joint between the rotor 110 and the supply-side end plate 117, a rubber O ring (not shown) is similarly arranged.

In the horizontal-type mechanical grinding mill 100, as shown by an arrow B1 in FIG. 3, the items to be ground D1 are supplied from the item-to-be-ground supply port 130. As shown in FIG. 4, the items to be ground D1 supplied to the horizontal-type mechanical grinding mill 100 are ground, in the grinding chamber 150, by repeating collision of the items to be ground D1 with the outer peripheral surface of the rotor 110 which rotates in the arrow C direction in the figures and with the inner peripheral surface of the fixed stator 120, and collision between the items to be ground D1.

In the cooling water supply-side rotary joint 113, the rotor cooling water inlet 111 for supplying the cooling water into the rotor 110 which rotates in the horizontal-type mechanical grinding mill 100 (arrow A1 in the figures) is provided. The cooling water supplied from the rotor cooling water inlet 111 is the brine supplied from the brine chiller 200.

When a temperature of the cooling water supplied from the rotor cooling water inlet 111 at the time of grinding operation of driving the horizontal-type mechanical grinding mill 100 is T1, the brine chiller 200 performs a temperature control so that T1 becomes “−20[° C.]≦T1≦0[° C.]”.

When a temperature of the cooling water supplied from the rotor cooling water inlet 111 at the time of grinding stop of stopping the horizontal-type mechanical grinding mill 100 is T2, the brine chiller 200 performs a temperature control so that T2 becomes “0[° C.]≦T2≦20[° C.]”.

At the time of starting up the horizontal-type mechanical grinding mill 100, the air volume of the grinding step is adjusted using the blower. The time of the grinding stop includes this period of adjusting control of the air volume and a blower stop period at the time of starting up.

In the cooling water discharge-side rotary joint 114, the rotor cooling water outlet 112 for discharging the cooling water that has passed through the rotor 110 which rotates in the horizontal-type mechanical grinding mill 100 (arrow A2 in the figures) is provided.

The horizontal-type mechanical grinding mill 100 includes a cooling jacket 125 on the outer side of the cylindrical stator 120, and a stator cooling water flow passage 128 for cooling down the stator 120 is formed. In the cooling jacket 125, a stator cooling water inlet 121 for supplying the cooling water to the stator cooling water flow passage 128 (arrow A3 in the figures) and a stator cooling water outlet 122 for discharging the cooling water in the stator cooling water flow passage 128 (arrow A4 in the figures) are formed.

The cooling water supplied from the stator cooling water inlet 121 is also the brine supplied from the brine chiller 200.

A temperature of the cooling water supplied from the stator cooling water inlet 121 at the time of the grinding operation is T1 which is the same as the temperature of the cooling water supplied from the rotor cooling water inlet 111 at the time of the grinding operation. Also, a temperature of the cooling water supplied from the stator cooling water inlet 121 at the time of the grinding stop is T2 which is the same as the temperature of the cooling water supplied from the rotor cooling water inlet 111 at the time of the grinding stop.

It should be noted that an exhaust temperature T3 in FIG. 2 indicates a temperature of the gas discharged from the ground item discharge port 140 of the horizontal-type mechanical grinding mill 100 together with the toner materials turned into the ground items D2.

Next, a process of one example of a toner manufacturing step to which the above horizontal-type mechanical grinding mill 100 can be applied will be described.

In general, the toner manufacturing step includes a material measurement and pre-mixing step, a melting and kneading step, a rolling and cooling step, an intermediate grinding step, a fine grinding step, a classifying step, and an additive agent applying step. The above horizontal-type mechanical grinding mill 100 is used in the fine grinding step.

### [Material Measurement and Pre-Mixing Step]

In the material measurement and pre-mixing step, at least predetermined amounts of resin and a coloring agent are weighed, blended, and mixed as toner raw material. One example of a mixing device includes a super mixer, a Henschel mixer, and a Nauta mixer. The measured raw material is blended to obtain mixed toner raw material.

### [Melting and Kneading Step]

In the melting and kneading step, the toner raw material obtained by mixing is melt and kneaded so as to melt the resin, and the coloring agent, wax, and the like therein are dispersed. Thereby, a colored resin composition is obtained.

In this melting and kneading step, a single or twin screw extruder capable of performing continuous production can be used. Such a single or twin screw extruder include, for example, the TEM twin screw extruder manufactured by TOSHIBA MACHINE CO., LTD., the twin screw extruder (MIRACLE K.C.K) manufactured by K.C.K Corporation, and the co-kneader (MDK, TSC) manufactured by BUSS.

### [Rolling and Cooling Step]

The colored resin composition obtained by melting and kneading the toner raw material is rolled by twin rolls or the like after melting and kneading, and cooled down via a cooling step of cooling by water cooling or the like. A rolling and cooling device used in this rolling and cooling step include, for example, the cooling belt cooler with press rollers manufactured by NIPPON STEEL CONVEYOR CO., LTD., the double belt cooler manufactured by NIPPON BELTING CO., LTD., and the Conti cooler manufactured by BBA.

### [Intermediate Grinding Step]

In the intermediate grinding step, the cooled colored resin composition obtained in the rolling and cooling step is ground to have a desired grain size with which the composition can be used as items to be ground in the fine grinding step. In the intermediate grinding step, the composition is coarsely ground by, for example, the pulverizer AP manufactured by HOSOKAWA MICRON CORPORATION, or an intermediate grinding mill such as the ACM pulverizer crusher, the hammer mill, and the feather mill manufactured by HOSOKAWA MICRON CORPORATION.

### [Fine Grinding Step]

The items to be ground of the colored resin composition coarsely ground in the intermediate grinding step are finely ground to have desired grain size in the fine grinding step. In the conventional fine grinding step, the turbo mill manufactured by Turbo Kogyo Co., Ltd., the inomizer manufactured by HOSOKAWA MICRON CORPORATION, the Kryptron manufactured by Kawasaki Heavy Industries, Ltd., the super rotor manufactured by Nisshin Engineering Inc., or the like are used as a grinding mill.

### [Classifying Step]

The grounded items of the colored resin composition obtained in the fine grinding step are classified into items within a range of grain size with which the items can be used as toner and items out of this range in the classifying step, to thereby toner particles are generated.

### [Additive Agent Applying Step]

Toner is obtained by adding an additive agent of fine particles to the toner particles generated in the classifying step. As a method of adding the additive agent to the toner particles, the toner particles and various known additive agents are blended by a predetermined amount, and agitated and mixed using a high speed agitator for applying shear force to powder such as a super mixer, a Henschel mixer, a Mechano Hybrid, and a Nobilta as an adding device.

In a toner manufacturing method of the present embodiment, a grinding mill including a plurality of primary grinding rotating elements (bar hammers) arranged on the same axis and a stationary element (grooved liner), the grinding mill for grinding by rotating the plurality of primary grinding rotating elements is used as the grinding mill used in the intermediate grinding step. However, the grinding mill used in the intermediate grinding step is not limited to this.

The above horizontal-type mechanical grinding mill 100 is used as the grinding mill for fine grinding. The horizontal-type mechanical grinding mill 100 is provided with a rotating element (rotor 110) including a rotating body having the concave and convex parts and being attached to the shaft 115 serving as the center rotation axis, and a stationary element (stator 120) having the concave and convex parts and being arranged around the rotating element while keeping a predetermined interval from the surface of the rotating element. In the horizontal-type mechanical grinding mill 100, a grinding zone is formed by the rotating element (rotor 110) and the stationary element (stator 120), and this grinding zone is housed in one unit. Also, in the present embodiment, the horizontal-type mechanical grinding mill is operated with the rotation number of the rotating element (rotor 110) being set to 5,700 [rpm].

As a result of research by the present inventors on manufacturing regarding fine particles of the toner manufactured by a grinding method, the following findings were obtained. That is, it is found that it is effective to perform grinding and classification of the toner particles in multiple stages so as to perform fine grinding (classification) after intermediate grinding (classification), which leads to a suppression of generation of coarse powder and fine powder that are not supposed to be a product, and then sharp grain size distribution can be obtained.

Therefore, the grinding device according to the present invention is useful in making the most of the intermediate grinding step, in further suppressing grinding energy in the existing grinding and classifying line, and in achieving the minimum investment cost.

In order to reduce the grain size to a maximum extent in the intermediate grinding step, a grinding is performed in the fine grinding step in which the plurality of rotating elements (bar hammers) arranged on the same axis for the intermediate grinding is rotated at the highest speed to perform grinding by an impact with the stationary element (grooved liner).

The horizontal-type mechanical grinding mill 100 is provided with the rotating element (rotor 110) including the rotating body having the concave and convex parts and being attached to the center rotation axis for the fine grinding, and the stationary element (stator 120) having the concave and convex parts and being arranged around the rotating element while keeping a predetermined interval from the surface of the rotating element.

When the horizontal-type mechanical grinding mill 100 is operated by the rotation number of 5,700 [rpm], a temperature of the items to be ground D1 passing through the horizontal-type mechanical grinding mill 100 is increased by heat generated by frictional between the air and the rotating element, frictional between the rotating element and the items to be ground D1, and the like.

As a configuration for preventing such a temperature increase, the horizontal-type mechanical grinding mill 100 includes the rotor cooling water flow passage 118 serving as a passage through which the cooling water passes in the rotor 110. Further, the cooling water is supplied from the rotor cooing water inlet 111, provided on the right side in FIG. 1, serving as the side of the ground item discharge port 140 in the axial direction of the rotation center axis E, and the cooling water is discharged from the rotor cooling water outlet 112, provided on the left side in FIG. 1, serving as the side of the item-to-be-ground supply port 130. In such a way, by supplying the cooling water from the side of the ground item discharge port 140, the just-supplied cooling water can cool down the toner materials serving as the items to be ground D1 on the side of the ground item discharge port 140 where the temperature of the items to be ground D1 is increased more than the side of the item-to-be-ground supply port 130. The just-supplied cooling water does not yet contribute to cooling and the temperature thereof is not yet increased. Thus, the toner materials on the side of the ground item discharge port 140, where the temperature tends to be increased, can be efficiently cooled down.

In FIG. 3 of Unexamined Japanese Patent Application Publication No. JP-2004-042029-A which shows the configuration in which the cooling water is supplied into the rotor from the side of a ground item discharge port, the cooling water inlet and outlet are placed on the same side. When the cooling water outlet is arranged on the side of the ground item discharge port as above, the cooling water which has been already used for cooling and reached the outlet has heat of an increased temperature which is transmitted to the cooling water before being used for cooling the rotor. Thus, cooling cannot be efficiently performed.

Meanwhile, in the horizontal-type mechanical grinding mill 100 of the present embodiment, the cooling water outlet is arranged on the opposite side of the inlet in the axial direction of the rotation center axis E. Therefore, the heat of the cooling water which has been already used for cooling can be prevented from being transmitted to the cooling water before being used for cooling, to thereby cooling can be efficiently performed.

FIG. 1 of Unexamined Japanese Patent Application Publication No. JP-2004-042029-A discloses the grinding device in which the cooling water is supplied into the rotor from the side of the ground item discharge port and the cooling water in the rotor is discharged from the side of the ground item supply port. However, the grinding device disclosed in FIG. 1 of Unexamined Japanese Patent Application Publication No. JP-2004-042029-A has the configuration in which the cooling water is supplied downward from the upper side. In a case of this configuration, even in a state where a cooling water route in the rotor is not filled with the cooling water, the cooling water supplied from an inlet of the cooling water route in the rotor flows downward due to gravitational force and is discharged from an outlet of the cooling water route in the rotor. In a state where the cooling water route in the rotor is not filled with the cooling water, efficiency of heat movement to the cooling water is deteriorated, and the toner materials cannot be efficiently cooled down.

Meanwhile, in the horizontal-type mechanical grinding mill 100 of the present embodiment, the rotation center axis E of the rotor 110 extends in a horizontal direction, and the cooling water flows in the rotor cooling water flow passage 118 by pressurizing the cooling water by a pump (not shown). In order to move the cooling water in the horizontal direction, there is a need for applying water pressure on the entire interior of the rotor cooling water flow passage 118. Therefore, in the horizontal-type mechanical grinding mill 100 of the present embodiment in which the cooling water is moved in the horizontal direction, the entire region of the rotor cooling water flow passage 118 is filled with the cooling water. In a state where the entire region of the rotor cooling water flow passage 118 is filled with the cooling water, the toner materials can be efficiently cooled down.

Also, in the present embodiment, the brine containing ethylene glycol is supplied as the cooling water supplied from the rotor cooling water inlet 111, and the temperature T1 of the cooling water supplied at the time of the grinding operation is set to −20[° C.]≦T1≦0[° C.]. The brine chiller 200 can control the temperature of the cooling water within a range from −20[° C.] to 20[° C.]. The temperature T1 of the cooling water supplied at the time of the grinding stop is set to 0[° C.]≦T1≦20[° C.]. Also, the horizontal-type mechanical grinding mill 100 includes a temperature gauge (not shown) for measuring the exhaust temperature T3, and controls the temperature of the cooling water supplied by the brine chiller 200 based on a measurement result of this temperature gauge. By this control, the exhaust temperature T3 is set within a range of 10[° C.]≦T3≦35[° C.].

By using the horizontal-type mechanical grinding mill 100 according to the present invention, agglomeration or melt of the toner ground items can be suppressed without introducing new facilities in the steps other than the fine grinding step, to thereby toner having reduced grain size can be stably supplied.

It is important for the toner materials (intermediate-ground items) which have passed through the intermediate grinding step and which is to be supplied to the fine grinding step to have grain size of about 20 to 200 [μm]. Reduction in the grain size of the intermediate-ground items to a maximum extent also contributes to low energy production of the fine grinding device (horizontal-type mechanical grinding mill 100).

As described above, by conducting the grinding step in which the fine grinding (classification) is performed after the intermediate grinding (classification), the grain size distribution is sharpened and the yield ratio and the productivity thereof are improved.

It is important for the stationary element (stator 120) arranged in the fine grinding mill (horizontal-type mechanical grinding mill 100) to have thermal conductivity improved by bringing into close contact with a jacket-type casing by a silicon coolant so as to remove grinding heat generated at the time of grinding by a cooing medium circulated inside. By making a temperature in the casing constant to some extent by this treatment, a state of constituent elements on surfaces of the toner particles can be controlled, and the same grinding effect can be given to toner particles having different grinding properties.

It is important for the rotating element (rotor 110) arranged in the fine grinding mill (horizontal-type mechanical grinding mill 100) to remove grinding heat generated at the time of grinding by circulating a cooling medium inside from the powder discharge direction to the powder charge direction. With respect to cooling of the above stationary element (stator 120), the rotating element (rotor 110) is directly cooled down, and thus, heat can be removed with a small amount of energy. Thereby, by controlling a temperature and an amount of the cooling medium itself, even when the rotation number of the rotating element (rotor 110) in the same device state is increased to 5,700 [rpm] which is a high speed rotation, heat can be easily removed from the toner materials.

The conventional mechanical grinding mills will be described below.

As the mechanical grinding mills, the turbo mills (Turbo Kogyo Co., Ltd.) described in Unexamined Japanese Patent Application Publication No. JP-2005-021768-A and Unexamined Japanese Patent Application Publication No. JP-H11-276916-A is used. Also, the fine mill (NIPPON PNEUMATIC MFG CO., LTD.) described in Unexamined Japanese Patent Application Publication No. JP-2003-117426-A, the Kryptron (Kawasaki Heavy Industries, Ltd.) described in Unexamined Japanese Patent Application Publication No. JP-2004-330062-A, and the like are used as well.

In these mechanical grinding mills, since an in-machine temperature increases at the time of grinding treatment, cooling is performed in consideration of an influence of welding on toner and colored resin powder to an interior thereof due to heat. A cooling method includes a method of attaching a jacket in an exterior of the mechanical grinding mill and cooling by cooling water (for example, see Examined Japanese Patent Application Publication No. JP-S63-66584-B(JP-S59-196754-A)), a method of reducing a temperature of the air flowing into the mechanical grinding mill together with items to be ground, and the like.

In a recent image formation device aiming for high quality images, digitalization and colorization are accelerated, and as a dry toner used therefor, there is an increasing demand for toner having reduced grain size or toner which enables fixing at a low temperature in order to respond to improvement of copying speed and an environmental issue. As a technique for manufacturing such toner, a technique for grinding toner by a grinding device, particularly by a rotation-type mechanical grinding device is conventionally known.

Specifically, Unexamined Japanese Patent Application Publication No. JP-S59-105853-A, Unexamined Japanese Patent Application Publication No. JP-H08-71439-A, Unexamined Japanese Patent Application Publication No. JP-H07-92733-A, Unexamined Japanese Patent Application Publication No. JP-H08-299827-A, Examined Japanese Patent Application Publication No. JP-H03-15489-B(JP-S63-104660-A), Unexamined Japanese Patent Application Publication No. JP-H05-269393-A, Unexamined Japanese Patent Application Publication No. JP-H07-155628-A, Examined Japanese Patent Application Publication No. JP-S61-36457-B(JP-S59-066362-A), Examined Japanese Patent Application Publication No. JP-S58-14822-B(JP-S55-97258-A), Examined Japanese Patent Application Publication No. JP-S58-14823-B(JP-S55-97259-A), Examined Japanese Patent Application Publication No. JP-S61-36459-B(JP-S59-073065-A), Examined Japanese Patent Application Publication No. JP-H04-12191-B(JP-S62-149352-A), Unexamined Japanese Patent Application Publication No. JP-H05-184960-A, Examined Japanese Patent Application Publication No. JP-H04-12190-B(JP-S62-149351-A), and the like disclose relevant techniques.

A configuration in which a cooling liquid flows into a rotor as in the horizontal-type mechanical grinding mill 100 of the present embodiment is described in Unexamined Japanese Patent Application Publication No. JP-2008-100188-A and the like. Although the invention of Unexamined Japanese Patent Application Publication No. JP-2008-100188-A regulates an area of cooling the water-cooling rotor rotation axis, a cooling medium flow passage is distant from a grinding point and flows in a round route having poor heat removal efficiency, and the cooling area is inefficient.

The mechanical grinding mill is required to easily obtain fine ground items of a few micron orders over a long period of time. When the conventional grinding devices are used to respond to this requirement, the following disadvantages arise which hinders a sufficient grinding in terms of stable production and quality.

(1) Fusion and fixation of the items to be ground occurs in the grinding mill due to friction, collision energy, or the like, to thereby a production ability (grinding ability) is lowered.
(2) Low molecules and Wax components in the composition of the items to be ground are deposited by an increase in grinding friction heat (temperature increase in the ground items by Δt[° C.]) due to a decrease in the grinding ability, to thereby toner quality is lowered. At 35[° C.] to 45[° C.], toner particles are agglomerated with each other, to thereby the quality is deteriorated. Further, at 45[° C.] or more, the toner particles start to be melted, to thereby the quality is deteriorated.
(3) The items to be ground are fixed in the grinding mill due to an environmental change (humidity), to thereby the grinding ability is lowered.
(4) Due to the above disadvantages (1) to (3), toner image quality (texture dirt, fixing failure, white spots, image density, and the like) is lowered.

With the horizontal-type mechanical grinding mill 100 of the present embodiment, the above problems can be solved, and fine ground items of a few micron orders can be easily obtained over a long period of time.

The horizontal-type mechanical grinding mill 100 is supported by the shaft 115 serving as a rotation axis member, and includes the rotor 110 in which a large number of concave and convex parts parallel to the axial direction are formed on the outer peripheral surface continuously in the circumferential direction. The horizontal-type mechanical grinding mill also includes the stator 120 arranged in an exterior of this rotor 110 to have a minute gap from the rotor, and provided with a large number of concave and convex parts parallel to the axial direction on the inner peripheral surface continuously in the circumferential direction. The items to be ground are finely ground in the grinding chamber 150 serving as the minute gap between the rotor 110 and the stator 120.

In the rotor 110, the rotor cooling water flow passage 118 through which the cooling water flows is provided, and the cooling water is supplied into the rotor 110 from the side of the ground item discharge port 140 and brought out from the side of the item-to-be-ground supply port 130. The temperature of the items to be ground D1 increases more on the side of the ground item discharge port 140 than on the side of the item-to-be-ground supply port 130. Thus, by supplying the cooling water into the rotor 110 from the side of the ground item discharge port 140, it is possible to make the most of an effect of lowering the temperature by the cooling water. Thereby, a temperature increase amount Δt of the ground items D2 discharged from the ground item discharge port 140 with respect to the temperature of the items to be ground D1 charged from the item-to-be-ground supply port 130 can be lowered.

At the time of generating the ground items, the items are desirably ground in such a manner that the exhaust temperature T3 is within a range of 10° C.≦T3≦35° C. This is because there is a fear of melt when a toner temperature reaches 35[° C.] or more.

Therefore, the brine chiller 200 is controlled in such a manner that the temperature T1 of the cooling water supplied at the time of the grinding operation is within a range of −20[° C.]≦T1≦0[° C.]. Thereby, even under a high rotation condition where the temperature is easily increased, the temperature increase amount Δt can be lowered, and even under the high rotation condition, occurrence of toner melt can be suppressed. Thus, the reduction in the grain size of the powder can be realized.

Meanwhile, the temperature T2 of the cooling water supplied at the time of the grinding stop is adjusted to be within a range of 0[° C.]≦T2≦20[° C.]. When the cooling water of less than 0[° C.] is continuously supplied upon the stop, a frost is generated or water is frozen at the time of opening the mechanical grinding mill or the like. In a state where the horizontal-type mechanical grinding mill is stopped, particularly in a case of a summer time when humidity is high in an atmosphere in which the toner is manufactured, ice (frost due to dew condensation) is generated and fixed between the rotor and the stator of the horizontal-type mechanical grinding mill. Therefore, a region in the vicinity of the rotor and the stator is required to be set in an unfrozen temperature region.

For this, by adjusting the temperature T2 of the cooling water at the time of the grinding stop to be within a range of 0[° C.]≦T2≦20[° C.], generation of a frost or freezing of water can be prevented.

When general water is used as the cooling water, the water become frozen even upon adjusting the temperature T1 of the cooling water supplied at the time of the grinding operation to be within a range of −20[° C.]≦T1≦0[° C.], to thereby the cooling water cannot be supplied. For this, the brine serving as a low-temperature heat medium containing ethylene glycol, propylene glycol, or the like is used as the cooling liquid.

When the horizontal-type mechanical grinding mill is rotated in an idling state, a temperature of the air passing through the ground item discharge port 140 with respect to a temperature of the air passing through the item-to-be-ground supply port 130 is increased by about 20 to 25[° C.] by air friction between the rotor 110 and the stator 120. When the toner temperature reaches 35[° C.] or more, the toner is melted. Thus, there is a need for suppressing the temperature increase due to heat generation at the time of toner grinding to about 10[° C.] or less. The toner materials are ground in the gap of about 1 [mm] between the rotor 110 and the stator 120 of the horizontal-type mechanical grinding mill 100 and made to have small grain size in proportion to an increase in the rotation number of the rotor 110. The temperature is also increased in proportion to the increase in the rotation number of the rotor 110.

In order to adjust the cooling water within the above range of the temperature T1 and the range of the temperature T2, the brine chiller 200 is configured to adjust the temperature of the cooling water within a range from −20[° C.] to 20[° C.].

When the rotation number of the rotor 110 is N1, the horizontal-type mechanical grinding mill 100 is within a range of “2,000 [rpm]≦N1≦5,700 [rpm]”. When the rotor rotates at high speed in such a way, a temperature of bearings 300 (300a, 300b) is easily increased to become a high temperature by frictional heat.

In the horizontal-type mechanical grinding mill 100, since the cooling water passes through the routes (215a, 215b) passing through the bearings 300, the frictional heat of the bearings 300 due to high speed rotation can be removed. Also, by heat propagation, a temperature of the first bearing 300a on the side of the ground item discharge port 140 where the items to be ground D1 easily reaches a higher temperature that of the second bearing 300b. However, since the low-temperature cooling water supplied from the rotor cooling water inlet 111 passes through inside the first bearing 300a, the first bearing 300a whose temperature easily become high can be efficiently cooled down.

In the horizontal-type mechanical grinding mill 100, the cooling water supply-side rotary joint 113 and the cooling water discharge-side rotary joint 114 are rotary joints capable of bearing high speed rotation of the rotation number of 5,700 [rpm].

A proof stress yield point of the end plates (116, 117) provided on both sides of the rotor 110 is 240 [N/mm²] or more, and end plate maximum deflection is 1/4 or less. Also, rubber hardness of the O rings (not shown) arranged in the joints between the rotor 110 and the end plates (116, 117) is Hs 90 or more.

By rotating the rotor of the horizontal-type mechanical grinding mill at high speed, an effect of preventing cooling water leakage from joint parts between mechanical parts can be obtained.

As shown in FIG. 2, the rotor 110 is formed by three or four blocks including powder grinding teeth, and further, the end plates (116, 177) are arranged on both ends in the axial direction.

As shown in FIG. 1, the cooling water is supplied into the rotor 110 via the end plates (116, 117). The cooling water flowing into the rotor 110 from the discharge-side end plate 116 receives centrifugal force at the time of rotation, to thereby the water leakage easily occurs at a point where the flow passage is bent at 90[°] and leading to the rotor 110.

When the end plates (116, 117) receive the centrifugal force by the high speed rotation and force of the proof stress yield point is weak, the end plates are deflected, the O rings at the deflected points are unbearably deformed, and the cooling water is leaked out from the deformed parts. Also, when rubber of the O rings is soft, the leakage of the cooling water is occurred due to deformation. Further, when a part of the rubber is damaged and mixed into the ground items, stable toner quality cannot be maintained. Therefore, by regulating this deflection of the end plates and the hardness of the O rings, the water leakage of the cooling water due to damage to the O rings and mixture of foreign substances into the ground items can be prevented, to thereby a decrease in the toner quality can be prevented.

In the horizontal-type mechanical grinding mill 100, the brine chiller 200 supplies the cooling water to the rotor cooling water flow passage 118 in the rotor 110 and the stator cooling water flow passage 128 formed by the cooling jacket 125. The supplied cooling water uses the brine chiller 200. In order to ensure cooling quality, the cooling water is stored (circulated) within a range of 10 [m] or less by a distance in the horizontal direction and 5 [m] or less by vertical height from a main body of the horizontal-type mechanical grinding mill 100 including the rotor 110 and the stator 120.

Upon feeding the cooling water, in order to maintain the cooling quality of the cooling water, it is important to supply the cooling water to the horizontal-type mechanical grinding mill while applying as less pressure and less stress as possible. In a case where a water feed pipe route is elongated and the cooling water is transferred against the gravitational force, the cooling water is retained in the pipe route and the temperature is increased. Thus, heat cannot be stably removed and the desired toner quality cannot be ensured.

In the brine chiller 200 of the present embodiment, by storing the cooling water within a limited range of 10 [m] or less by the distance in the horizontal direction and 5 [m] or less by the vertical height, the temperature of the cooling water can be managed and controlled to +10[° C.] or less and −10[° C.] or more of a set value, to thereby heat can be stably removed.

Also, by including a header (not shown), the brine chiller 200 can respectively supply the cooling water to the side of the stator cooling water flow passage 128 and the side of the rotor cooling water flow passage 118 at the same time. Thereby, heat of the items to be ground D1 can be removed from both the side of the stator 120 and the side of the rotor 110.

In the horizontal-type mechanical grinding mill 100, a water content detector may be provided in the grinding chamber 150. There is a fear that the cooling water to be fed to the rotor cooling water flow passage 118 and the stator cooling water flow passage 128 is leaked out into the grinding chamber 150 from the O rings or the like installed in the joints between the rotor 110 and water passages of the end plates (116, 117) stopping the rotor from both sides. For this, by providing the water content detector in the grinding chamber 150 to promptly detect and respond to occurrence of the leakage of the cooling water, the decrease in the quality of the ground items due to mixture of the cooling water can be prevented, to thereby the quality of the ground items can be maintained.

In the horizontal-type mechanical grinding mill 100, when the rotor 110 is stopped, the cooling water to be supplied to the rotor cooling water flow passage 118 and the stator cooling water flow passage 128 is desirably adjusted to be not less than 0[° C.]. Also, heat retention and dew proof features are provided in supply pipes of the cooling water fed by the brine chiller 200 to the rotor cooling water flow passage 118 and the stator cooling water flow passage 128. Thereby, the cooling water can be supplied without an influence from an external environment.

In the horizontal-type mechanical grinding mill 100, a grinder rotates the rotor 110 attached to the horizontal-type rotation shaft. The horizontal-type mechanical grinding mill also has the stator 120 arranged around the rotor by 360[°] while keeping a predetermined interval from the surface of this rotor 110, on which stator the item-to-be-ground supply port 130 is arranged. Further, the cool air is inserted into the space formed by retaining the above gap. In this horizontal-type mechanical grinding mill 100, an antifreeze liquid is circulated inside the rotor 110 serving as the rotating element and in the cooling jacket 125 on the outer side of the stator 120.

In the horizontal-type mechanical grinding mill 100, at the time of generating the ground items, in order to perform grinding with the exhaust temperature T3 of “10[° C.]≦T3≦35[° C.]”, the temperature T1 of the cooling water supplied into the rotor 110 at the time of the grinding operation is preferably within a range of “−20[° C.]≦T1≦−0[° C.]”. The range is more preferably “−20[° C.]≦T1≦−10[° C.]”, and further preferably “−20[° C.]≦T1≦−16[° C.]”. However, when the temperature becomes less than “−20[° C.],” a temperature of the device exceeds 30[° C.] at the time of the stop in a summer time. Since a temperature difference exceeds 50[° C.] at this time, the mechanical device becomes brittle due to an increase in metal fatigue. Thus, there is a fear that stable ground items cannot be supplied.

The proof stress yield point of the end plates on both the sides of the rotor 110 is preferably 240 [N/mm²] or more, more preferably 250 [N/mm²] or more, and further preferably 260 [N/mm²] or more. When the proof stress yield point of the end plates becomes less than 240 [N/mm²], the end plates are deflected due to the centrifugal force or the like applied by rotation, and the O rings at the deflected points are unbearably deformed. Thus, there is a fear that the cooling water is leaked out from the deformed points. The same applies in the end plate maximum deflection, which is preferably 1/4 or less, more preferably 3/16 or less, and further preferably 1/8 or less.

In order not to leak the cooling water out, the rubber hardness of the O rings of the cooling water flow passages in the joints between the end plates and the rotor is preferably Hs 90 or more, more preferably Hs 92 or more, and further preferably Hs 95 or more. However, when the rubber hardness is less than Hs 90, deformation progresses due to softness of the rubber, and at the time of high rotation of the rotor of the mechanical grinding mill, the cooling water is leaked out. When the cooling water is mixed into the ground items, stable quality cannot be maintained.

### [Experimental Case]

Next, an experimental case in which a manufactured toner performance is compared between Examples of using a grinding device provided with the configuration of the present invention as the grinding mill for fine grinding, and Comparative Examples of using a grinding device not provided with the configuration of the present invention will be described.

In the experimental case, a mixture of the following composition was melt, kneaded, cooled down, and then coarsely ground, to obtain coarse ground items having average grain size of about 400 [μm]. The coarse ground items were ground by the grinding mill for fine grinding.

### <Composition of Mixture>

Styrene acrylic copolymer: 100 [wt %]
Carbon black: 10 [wt %]
Polypropylene: 5 [wt %]
Zinc salicylate: 2 [wt %]

In the experimental case, grain size of the ground items after grinding was measured by a Coulter counter, to obtain weight-average grain size, and circularity was measured by a FPIA.

A measurement device of grain size distribution of toner particles by the Coulter counter method includes the Coulter counter TA-II and the Coulter Multisizer II (both manufactured by Coulter Corporation). A measuring method will be described below.

Firstly, 0.1 to 5 [ml] of surfactant (preferably, alkyl benzene sulfonate) is added into 100 to 150 [ml] of electrolyte solution as a dispersant. The electrolyte solution is made by preparing an about-1% NaCl solution using primary sodium chloride, and for example, ISOTON II (produced by Coulter Corporation) can be used. Herein, 2 to 20 [mg] of measurement sample is further added. The electrolyte solution in which the sample is suspended is dispersed for about 1 to 3 [min] by an ultrasonic disperser. After that, by the measurement device and using 100 μm aperture, number distribution of channels of grain size is measured. From the obtained distribution, weight-average grain size (D4) and number-average grain size of the toner can be determined.

As the channels, thirteen channels including channels of: 2.00 to less than 2.52 [μm]; 2.52 to less than 3.17 [μm]; 3.17 to less than 4.00 [μm]; 4.00 to less than 5.04 [μm]; 5.04 to less than 6.35 [μm]; 6.35 to less than 8.00 [μm]; 8.00 to less than 10.08 [μm]; 10.08 to less than 12.70 [μm]; 12.70 to less than 16.00 [μm]; 16.00 to less than 20.20 [μm]; 20.20 to less than 25.40 [μm]; 25.40 to less than 32.00 [μm]; and 32.00 to less than 40.30 [μm] are used, and particles having grain size of 2.00 [μm] or more to less than 40.30 [μm] are targeted.

The circularity of the particles is measured using the flow-type particle image analysis device “FPIA-1000” manufactured by TOA MEDICAL ELECTRONICS, INC.

Upon the measurement, minute dust is removed through a filter. As a result, a few drops of non-ionic surfactant (preferably, CONTAMINON N made by Wako Pure Chemical Industries, Ltd.) are added into 10 [ml] of water in which the particle number is 20 or less in a measurement range (for example, a circle-equivalent diameter of 0.60 [μm] or more and less than 159.21 [μm]) in 10⁻³ [cm³] of water. Further, 5 [mg] of measurement sample is added, and dispersion treatment is performed for one minute by the ultrasonic disperser UH-50 manufactured by SMT Corporation under the condition of 20 [kHz], 50 [W]/10 [cm³]. Further, dispersion treatment is performed for five minutes in total. After that, using a sample dispersant liquid having particle concentration of the measurement sample of 4,000 to 8,000/10⁻³ [cm³] (targeting particles within a measurement circle-equivalent diameter range), grain size distribution of particles having the circle-equivalent diameter of 0.60 [μm] or more and less than 159.21 [μm] is measured.

The sample dispersant liquid passes through a flow passage (spreading along the flow direction) of a flat and transparent flow cell (thickness of about 200 [μm]). In order to form an optical passage passing while crossing the thickness of the flow cell, a strobe lamp and a CCD camera are installed to be placed on the opposite sides to each other with respect to the flow cell. While the sample dispersant liquid flows, strobe light is irradiated at intervals of 1/30 seconds in order to obtain images of the particles flowing through the flow cell. As a result, each of the particles is photographed as a two-dimensional image having a fixed range parallel to the flow cell. From an area of the two-dimensional image of each of the particles, the diameter of the circle having the same area is calculated as the circle-equivalent diameter.

For about one minute, the circle-equivalent diameters of 1,200 or more particles can be measured and the number and the ratio of the particle having the regulated circle-equivalent diameter (the number [%]) based on circle-equivalent diameter distribution can be measured. The result (frequency [%] and accumulation [%]) can be obtained by dividing a range from 0.06 to 400 [μm] into 226 channels (30 channels are allotted to one octave) as shown in Table 1 to be described later. In actual measurement, the particles are measured with the circle-equivalent diameter within the range of 0.60 [μm] or more and less than 159.21 [μm].

In Examples, as the grinding mill for fine grinding, a grinding mill having a passage through which cooling water flows into a rotor, the cooling water is supplied into the rotor from the side of a ground item discharge port, and the cooling water in the rotor is discharged from the side of an item-to-be-ground supply port as in the above horizontal-type mechanical grinding mill 100 is used. Also, as a method of supplying the cooling water in Examples, a method including rotary joints (113, 114) capable of bearing the high speed rotation number of 5,700 [rpm] is used.

### Example 1

Under the condition that grinding is performed with the horizontal-type mechanical grinding mill 100, the temperature T1 of the cooling water supplied into the rotor is set to −20[° C.] and the force of the proof stress yield point of the end plates on both sides of the rotor is set to 260 [N/mm²]. The end plate maximum deflection (ratio with respect to the entire width) is 1/8, and the rubber hardness of the O rings of the cooling water passages where the end plates and the rotor are in contact with each other is Hs 95. Further, the circumferential speed of the rotor is set to 180 [m/sec] (5,700 [rpm]), and the supply amount of the toner materials serving as the items to be ground D1 is 120 [kg/hr].

When grinding was performed under such a condition, the evaluation result confirmed that the toner grain size distribution was made very sharp and the toner average grain size was 6.0 to 6.9 [μm]. The electric charge amount of the toner and the physical property evaluation were favorable. Further, when the image evaluation of an actual machine was performed by the RICOH copier, the image evaluation was very favorable.

### Example 2

Under the condition that grinding is performed with the horizontal-type mechanical grinding mill 100, the temperature T1 of the cooling water supplied into the rotor is set to −10[° C.] and the force of the proof stress yield point of the end plates on both sides of the rotor is set to 260 [N/mm²]. The end plate maximum deflection (ratio with respect to the entire width) is 1/8, and the rubber hardness of the O rings of the cooling water passages where the end plates and the rotor are in contact with each other is Hs 95. Further, the circumferential speed of the rotor is set to 180 [m/sec] (5,700 [rpm]), and the supply amount of the toner materials is 120 [kg/hr].

When grinding was performed under such a condition, the evaluation result confirmed that the toner grain size distribution was made very sharp and the toner average grain size was 6.0 to 6.9 [μm]. The electric charge amount of the toner and the physical property evaluation were favorable. Further, when the image evaluation of an actual machine was performed by the RICOH copier, the image evaluation was favorable.

### Example 3

Under the condition that grinding is performed with the horizontal-type mechanical grinding mill 100, the temperature T1 of the cooling water supplied into the rotor is set to 0[° C.] and the force of the proof stress yield point of the end plates on both sides of the rotor is set to 260 [N/mm²]. The end plate maximum deflection (ratio with respect to the entire width) is 1/8, and the rubber hardness of the O rings of the cooling water passages where the end plates and the rotor are in contact with each other is Hs 95. Further, the circumferential speed of the rotor is set to 180 [m/sec] (5,700 [rpm]), and the supply amount of the toner materials is 120 [kg/hr].

When grinding was performed under such a condition, the evaluation result confirmed that the toner grain size distribution was made very sharp and the toner average grain size was 6.0 to 6.9 [μm]. The electric charge amount of the toner and the physical property evaluation were favorable. Further, when the image evaluation of an actual machine was performed by the RICOH copier, the image evaluation was favorable.

### Example 4

Under the condition that grinding is performed with the horizontal-type mechanical grinding mill 100, the temperature T1 of the cooling water supplied into the rotor is set to −20[° C.] and the force of the proof stress yield point of the end plates on both sides of the rotor is set to 250 [N/mm²]. The end plate maximum deflection (ratio with respect to the entire width) is 3/16, and the rubber hardness of the O rings of the cooling water passages where the end plates and the rotor are in contact with each other is Hs 92. Further, the circumferential speed of the rotor is set to 180 [m/sec] (5,700 [rpm]), and the supply amount of the toner materials is 120 [kg/hr].

When grinding was performed under such a condition, the evaluation result confirmed that the toner grain size distribution was made very sharp and the toner average grain size was 6.0 to 6.9 [μm]. The electric charge amount of the toner and the physical property evaluation were favorable. Further, when the image evaluation of an actual machine was performed by the RICOH copier, the image evaluation was very favorable.

### Example 5

Under the condition that grinding is performed with the horizontal-type mechanical grinding mill 100, the temperature T1 of the cooling water supplied into the rotor is set to −10[° C.] and the force of the proof stress yield point of the end plates on both sides of the rotor is set to 250 [N/mm²]. The end plate maximum deflection (ratio with respect to the entire width) is 3/16, and the rubber hardness of the O rings of the cooling water passages where the end plates and the rotor are in contact with each other is Hs 92. Further, the circumferential speed of the rotor is set to 180 [m/sec] (5,700 [rpm]), and the supply amount of the toner materials is 120 [kg/hr].

When grinding was performed under such a condition, the evaluation result confirmed that the toner grain size distribution was made very sharp and the toner average grain size was 6.0 to 6.9 [μm]. The electric charge amount of the toner and the physical property evaluation were favorable. Further, when the image evaluation of an actual machine was performed by the RICOH copier, the image evaluation was favorable.

### Example 6

Under the condition that grinding is performed with the horizontal-type mechanical grinding mill 100, the temperature T1 of the cooling water supplied into the rotor is set to 0[° C.] and the force of the proof stress yield point of the end plates on both sides of the rotor is set to 250 [N/mm²]. The end plate maximum deflection (ratio with respect to the entire width) is 3/16, and the rubber hardness of the O rings of the cooling water passages where the end plates and the rotor are in contact with each other is Hs 92. Further, the circumferential speed of the rotor is set to 180 [m/sec] (5,700 [rpm]), and the supply amount of the toner materials is 120 [kg/hr].

When grinding was performed under such a condition, the evaluation result confirmed that the toner grain size distribution was made very sharp and the toner average grain size was 6.0 to 6.9 [μm]. The electric charge amount of the toner and the physical property evaluation were favorable. Further, when the image evaluation of an actual machine was performed by the RICOH copier, the image evaluation was favorable.

Table 1 shows the experiment conditions of Examples 1 to 6, and Table 2 shows the experiment results.

TABLE 1

| | EXAMPLE | EXAMPLE | EXAMPLE | EXAMPLE | EXAMPLE | EXAMPLE |
|---|---|---|---|---|---|---|
| | 1 | 2 | 3 | 4 | 5 | 6 |
| COOLING WATER FLOW PASSAGE | FLOW PASSAGE IN WHICH COOLING WATER IS BROUGHT INTO | | | | | |
| HAVING PASSAGE THROUGH WHICH | ROTOR FROM DISCHARGE PORT SIDE AND COMES OUT FROM | | | | | |
| COOLING WATER FLOWS INTO | CHARGE PORT SIDE | | | | | |
| ROTOR | | | | | | |
| TEMPERATURE T1 OF COOLING | −20 [° C.] | −10 [° C.] | 0 [° C.] | −20 [° C.] | −10 [° C.] | 0 [° C.] |
| WATER SUPPLIED INTO ROTOR OF | | | | | | |
| MECHANICAL GRINDING MILL | | | | | | |

| MECHANISM HAVING PASSAGE | ROTARY JOINTS CAPABLE OF BEARING | |
|---|---|---|
| THROUGH WHICH COOLING WATER | ROTATION NUMBER OF 5,700 [rpm] | |
| FLOWS FOR SUPPLYING COOLING | | |
| WATER INTO ROTOR | | |
| FORCE OF PROOF STRESS YIELD | 260 [N/mm²] | 250 [N/mm²] |
| POINT OF END PLATES ON BOTH | | |
| SIDES OF ROTOR | | |
| END PLATE MAXIMUM DEFLECTION | 1/8 | 3/16 |
| (RATIO WITH RESPECT TO ENTIRE | | |
| WIDTH) | | |
| RUBBER HARDNESS OF O RINGS OF | Hs95 | Hs92 |
| COOLING WATER PASSAGE WHERE | | |
| END PLATES AND ROTOR ARE IN | | |
| CONTACT WITH EACH OTHER | | |

| | |
|---|---|
| ROTOR CIRCUMFERENTIAL SPEED | 180 [m/sec] |
| SUPPLY AMOUNT | 120 [kg/hr] |

TABLE 2

| | EXAMPLE 1 | EXAMPLE 2 | EXAMPLE 3 | EXAMPLE 4 | EXAMPLE 5 | EXAMPLE 6 |
|---|---|---|---|---|---|---|
| TONER GRAIN SIZE | VERY | SHARP | SLIGHTLY | VERY | SHARP | SLIGHTLY |
| DISTRIBUTION | SHARP | | SHARP | SHARP | | SHARP |
| TONER AVERAGE | 6.0-6.9 [μm] | 6.0-6.9 [μm] | 6.0-6.9 [μm] | 6.0-6.9 [μm] | 6.0-6.9 [μm] | 6.0-6.9 [μm] |
| GRAIN SIZE | | | | | | |
| TONER ELECTRIC | 25.8 | 24.9 | 24.6 | 25.7 | 24.7 | 24.3 |
| CHARGE AMOUNT | | | | | | |
| IMAGE | A | B | B | A | B | B |
| EVALUATION | | | | | | |

Determination criteria of the image evaluation of Table 2 and Table 4 to be described later are as follows.

“A”: Excellent in comparison to conventional example
“B”: Better than conventional example
“C”: Same as conventional example
“D”: Inferior to conventional example

Next, current situations will be shown as Comparative Examples. In Comparative Examples, a cooling water flow passage having a passage through which cooling water flows into a rotor is a flow passage in which the cooling water is brought into the rotor from the side of a charge port (item-to-be-ground supply port 130) and comes out from the side of a discharge port (ground item discharge port 140). That is, in Comparative Examples, regarding supply of the cooling water into the rotor, the cooling water is supplied from a point serving as the rotor cooling water outlet 112 in the horizontal-type mechanical grinding mill 100 shown in FIG. 1, and the cooling water is discharged from a point serving as the rotor cooling water inlet 111. Hereinafter, this configuration will be referred to as the “conventional grinding mill”. Also, as a mechanism for supplying the cooling water in Comparative Examples, rotary joints capable of bearing the rotation number of 5,200 [rpm] were used.

### Comparative Example 1

Under the condition that grinding is performed with the conventional grinding mill, the temperature T1 of the cooling water supplied into the rotor is set to −20[° C.] and the force of the proof stress yield point of the end plates on both the sides of the rotor is set to 230 [N/mm²]. The end plate maximum deflection (ratio with respect to the entire width) is 5/16, and the rubber hardness of the O rings of the cooling water passages where the end plates and the rotor are in contact with each other is Hs 88. Further, the circumferential speed of the rotor is set to 163 [m/sec] (5,200 [rpm]), and the supply amount of the toner materials is 120 [kg/hr].

When grinding was performed under such a condition, the evaluation result confirmed that the toner grain size distribution was made broad and the toner average grain size was 7.0 to 9.0 [μm]. The electric charge amount of the toner and the physical property evaluation were the same as the conventional example. Further, when the image evaluation of an actual machine was performed by the RICOH copier, the image evaluation was within the standard.

### Comparative Example 2

Under the condition that grinding is performed with the conventional grinding mill, the temperature T1 of the cooling water supplied into the rotor is set to −10[° C.] and the force of the proof stress yield point of the end plates on both the sides of the rotor is set to 230 [N/mm²]. The end plate maximum deflection (ratio with respect to the entire width) is 5/16, and the rubber hardness of the O rings of the cooling water passages where the end plates and the rotor are in contact with each other is Hs 88. Further, the circumferential speed of the rotor is set to 163 [m/sec](5,200 [rpm]), and the supply amount of the toner materials is 120 [kg/hr].

When grinding was performed under such a condition, the evaluation result confirmed that the toner grain size distribution was made broad and the toner average grain size was 7.0 to 9.0 [μm]. The electric charge amount of the toner and the physical property evaluation were the same as the conventional example. Further, when the image evaluation of an actual machine was performed by the RICOH copier, the image evaluation was within the standard.

### Comparative Example 3

Under the condition that grinding is performed with the conventional grinding mill, the temperature T1 of the cooling water supplied into the rotor is set to 0[° C.] and the force of the proof stress yield point of the end plates on both the sides of the rotor is set to 230 [N/mm²]. The end plate maximum deflection (ratio with respect to the entire width) is 5/16, and the rubber hardness of the O rings of the cooling water passages where the end plates and the rotor are in contact with each other is Hs 88. Further, the circumferential speed of the rotor is set to 163 [m/sec](5,200 [rpm]), and the supply amount of the toner materials is 120 [kg/hr].

When grinding was performed under such a condition, the evaluation result confirmed that the toner grain size distribution was made slightly broad and the toner average grain size was 7.0 to 9.0 [μm]. The electric charge amount of the toner and the physical property evaluation were non-compliant. Further, when the image evaluation of an actual machine was performed by the RICOH copier, the image evaluation was non-compliant.

### Comparative Example 4

Under the condition that grinding is performed with the conventional grinding mill, the temperature T1 of the cooling water supplied into the rotor is set to −20[° C.] and the force of the proof stress yield point of the end plates on both the sides of the rotor is set to 200 [N/mm²]. The end plate maximum deflection (ratio with respect to the entire width) is 3/8, and the rubber hardness of the O rings of the cooling water passages where the end plates and the rotor are in contact with each other is Hs 85. Further, the circumferential speed of the rotor is set to 163 [m/sec] (5,200 [rpm]), and the supply amount of the toner materials is 120 [kg/hr].

When grinding was performed under such a condition, the evaluation result confirmed that the toner grain size distribution was made slightly broad and the toner average grain size was 7.0 to 9.0 [μm]. The electric charge amount of the toner and the physical property evaluation were the same as the conventional example. Further, when the image evaluation of an actual machine was performed by the RICOH copier, the image evaluation was non-compliant.

### Comparative Example 5

Under the condition that grinding is performed with the conventional grinding mill, the temperature T1 of the cooling water supplied into the rotor is set to −10[° C.] and the force of the proof stress yield point of the end plates on both the sides of the rotor is set to 200 [N/mm²]. The end plate maximum deflection (ratio with respect to the entire width) is 3/8, and the rubber hardness of the O rings of the cooling water passages where the end plates and the rotor are in contact with each other is Hs 85. Further, the circumferential speed of the rotor is set to 163 [m/sec] (5,200 [rpm]), and the supply amount of the toner materials is 120 [kg/hr].

When grinding was performed under such a condition, the evaluation result confirmed that the toner grain size distribution was made slightly broad and the toner average grain size was 7.0 to 9.0 [μm]. The electric charge amount of the toner and the physical property evaluation were non-compliant. Further, when the image evaluation of an actual machine was performed by the RICOH copier, the image evaluation was non-compliant.

### Comparative Example 6

Under the condition that grinding is performed with the conventional grinding mill, the temperature T1 of the cooling water supplied into the rotor is set to 0[° C.] and the force of the proof stress yield point of the end plates on both the sides of the rotor is set to 200 [N/mm²]. The end plate maximum deflection (ratio with respect to the entire width) is 3/8, and the rubber hardness of the O rings of the cooling water passages where the end plates and the rotor are in contact with each other is Hs 85. Further, the circumferential speed of the rotor is set to 163 [m/sec] (5,200 [rpm]), and the supply amount of the toner materials is 120 [kg/hr].

When grinding was performed under such a condition, the evaluation result confirmed that the toner grain size distribution was made slightly broad and the toner average grain size was 7.0 to 9.0 [μm]. The electric charge amount of the toner and the physical property evaluation were non-compliant. Further, when the image evaluation of an actual machine was performed by the RICOH copier, the image evaluation was non-compliant.

Table 3 shows the experiment conditions of Comparative Examples 1 to 6, and Table 4 shows the experiment results.

TABLE 3

| | COM- | COM- | COM- | COM- | COM- | COM- |
|---|---|---|---|---|---|---|
| | PARATIVE | PARATIVE | PARATIVE | PARATIVE | PARATIVE | PARATIVE |
| | EXAMPLE 1 | EXAMPLE 2 | EXAMPLE 3 | EXAMPLE 4 | EXAMPLE 5 | EXAMPLE 6 |
| COOLING WATER FLOW PASSAGE | FLOW PASSAGE IN WHICH COOLING WATER IS BROUGHT INTO | | | | | |
| HAVING PASSAGE THROUGH WHICH | ROTOR FROM CHARGE PORT SIDE AND COMES OUT FROM | | | | | |
| COOLING WATER FLOWS INTO | DISCHARGE PORT SIDE | | | | | |
| ROTOR | | | | | | |
| TEMPERATURE T1 OF COOLING | −20 [° C.] | −10 [° C.] | 0 [° C.] | −20 [° C.] | −10 [° C.] | 0 [° C.] |
| WATER SUPPLIED INTO ROTOR OF | | | | | | |
| MECHANICAL GRINDING MILL | | | | | | |

| MECHANISM HAVING PASSAGE | ROTARY JOINTS CAPABLE OF BEARING | |
|---|---|---|
| THROUGH WHICH COOLING WATER | ROTATION NUMBER OF 5,200 [rpm] | |
| FLOWS FOR SUPPLYING COOLING | | |
| WATER INTO ROTOR | | |
| FORCE OF PROOF STRESS YIELD | 230 [N/mm²] | 200 [N/mm²] |
| POINT OF END PLATES ON BOTH | | |
| SIDES OF ROTOR | | |
| END PLATE MAXIMUM DEFLECTION | 5/16 | 3/8 |
| (RATIO WITH RESPECT TO ENTIRE | | |
| WIDTH) | | |
| RUBBER HARDNESS OF O RINGS OF | Hs88 | Hs85 |
| COOLING WATER PASSAGE WHERE | | |
| END PLATES AND ROTOR ARE IN | | |
| CONTACT WITH EACH OTHER | | |

| | |
|---|---|
| ROTOR CIRCUMFERENTIAL SPEED | 163 [m/sec] |
| SUPPLY AMOUNT | 120 [kg/hr] |

TABLE 4

| | COMPARATIVE | COMPARATIVE | COMPARATIVE | COMPARATIVE | COMPARATIVE | COMPARATIVE |
|---|---|---|---|---|---|---|
| | EXAMPLE 1 | EXAMPLE 2 | EXAMPLE 3 | EXAMPLE 4 | EXAMPLE 5 | EXAMPLE 6 |
| TONER GRAIN SIZE | BROAD | BROAD | SLIGHTLY | BROAD | SLIGHTLY | SLIGHTLY |
| DISTRIBUTION | | | BROAD | | BROAD | BROAD |
| TONER AVERAGE | 7.0-9.0 [μm] | 7.0-9.0 [μm] | 7.0-9.0 [μm] | 7.0-9.0 [μm] | 7.0-9.0 [μm] | 7.0-9.0 [μm] |
| GRAIN SIZE | | | | | | |
| TONER ELECTRIC | 23.0 | 22.2 | 20.3 | 20.7 | 20.5 | 20.1 |
| CHARGE AMOUNT | | | | | | |
| IMAGE | C | C | D | D (BRINE | D (BRINE | D (BRINE |
| EVALUATION | | | | CHILLER | CHILLER | CHILLER |
| | | | | LEAKAGE) | LEAKAGE) | LEAKAGE) |

The above description shows one example, and the present invention has a peculiar effect for each of the following modes.

### (Mode A)

A mechanical grinding device such as the horizontal-type mechanical grinding mill 100 includes a cylindrical stator such as the stator 120, a columnar rotor such as the rotor 110 arranged inside the stator in such a manner that the center axis overlies the center axis of the stator, the rotor being rotatable about the center axis, a grinding chamber such as the grinding chamber 150 formed in a gap between an inner peripheral surface of the stator and an outer peripheral surface of the rotor, the grinding chamber being configured to have an inside through which an item to be ground such as the items to be ground D1 passes, to thereby the item to be ground is ground by rotating the rotor, an item-to-be-ground supply port such as the item-to-be-ground supply port 130 for supplying the item to be ground to the grinding chamber, the item-to-be-ground supply port being provided in one end in the axial direction parallel to the center axis in the grinding chamber, a ground item discharge port such as the ground item discharge port 140 for discharging a ground item obtained by grinding the item to be ground, the ground item discharge port being provided in the other end in the axial direction in the grinding chamber, and a cooling water supplying unit such as the brine chiller 200 for supplying cooling water to a cooling water flow passage such as the rotor cooling water flow passage 118 provided inside the rotor, wherein the axial direction is the horizontal direction, a cooling water inlet such as the rotor cooling water inlet 111 from which the cooling water is brought into the cooling water flow passage is provided in the rotor on the side of the ground item discharge port in the axial direction, and a cooling water outlet such as the rotor cooling water outlet 112 from which the cooling water comes out after passing through the cooling water flow passage is provided in the rotor on the side of the item-to-be-ground supply port in the axial direction.

According to this mode, as in the description of the above embodiment, the items to be ground in the vicinity of the ground item discharge port can be cooled down by the cooling liquid having a low temperature before contributing to cooling. Thus, the items to be ground can be cooled down more efficiently than the conventional example.

### (Mode B)

In Mode A, the inner peripheral surface of the stator is formed in such a manner that a concave part and a convex part extending in parallel to the axial direction are alternately continued in the circumferential direction, and the outer peripheral surface of the rotor is formed in such a manner that a concave part and a convex part extending in parallel to the axial direction are alternately continued in the circumferential direction.

According to this mode, as in the description of the above embodiment, a configuration of grinding by repeating collision of the items to be ground with the outer peripheral surface of the rotating rotor and the inner peripheral surface of the fixed stator and collision between the items to be ground in the grinding chamber can be realized.

### (Mode C)

In Mode A or B, the cooling water is brine containing ethylene glycol, and a temperature of a gas discharged from the ground item discharge port together with the ground item is adjusted to be within a range from 10[° C.] or more to 35[° C.] or less by adjusting a temperature of the cooling water supplied to the cooling water inlet within a range from −20[° C.] or more to 0[° C.] or less when a grinding action is performed, and by adjusting the temperature within a range from 0[° C.] or more to 20[° C.] or less when the grinding action is not performed.

According to this mode, as in the description of the above embodiment, even under the high rotation condition, the items to be ground can be suppressed from having a high temperature. Thus, the reduction in the grain size of the ground items can be realized.

### (Mode D)

In any of Modes A to C, the rotation number of the rotor is 2,000 [rpm] or more and 5,700 [rpm] or less, and the cooling water passes through a bearing member such as the bearings 300 for supporting the rotor rotatably with respect to a casing of a device main body.

According to this mode, as in the description of the above embodiment, the bearing member whose temperature easily becomes high by the high speed rotation can be efficiently cooled down.

### (Mode E)

In any of Modes A to D, rotary joints such as the cooling water supply-side rotary joint 113 and the cooling water discharge-side rotary joint 114 corresponding to the rotation number of 5,700 [rpm] are provided in the cooling water inlet and the cooling water outlet, a proof stress yield point of end plates such as the discharge-side end plate 116 and the supply-side end plate 117 arranged on the both end sides in the axial direction of the rotor is 240 [N/mm²] or more, maximum deflection of the end plates is 1/4 or less, each of the end plates includes an intra-end plate flow passage such as the intra-discharge-side end plate flow passage 216 or the intra-supply-side end plate flow passage 217 through which the cooling water passes, an O ring made of an elastic body is provided in a border between the intra-end plate flow passage and the cooling water flow passage, and rubber hardness of the O ring is Hs 90 or more.

According to this mode, as in the description of the above embodiment, the water leakage of the cooling water due to damage to the O ring and the mixture of foreign substances into the ground items can be prevented, to thereby the decrease in the toner quality can be prevented.

### (Mode F)

In any of Modes A to E, the cooling water supplying unit stores the cooling water within a range of 10 [m] or less by a distance in the horizontal direction and 5 [m] or less by vertical height from the rotor.

According to this mode, as in the description of the above embodiment, the temperature of the cooling water can be managed and controlled to be +10[° C.] or less and −10[° C.] or more of the set value, to thereby heat can be stably removed.

### (Mode G)

In any of Modes A to F, a water content detector is provided in the grinding chamber.

According to this mode, as in the description of the above embodiment, by promptly detecting and responding to the generation of the leakage of the cooling water, the decrease in the quality of the ground items due to the mixture of the cooling water can be prevented, to thereby the quality of the ground items can be maintained.

### (Mode H)

In any of Modes A to G when the grinding action is not performed, the temperature of the cooling water supplied to the cooling water inlet is adjusted to be not less than 0[° C.], and heat retention and dew proof features are provided in a supply pipe through which the cooling water supplying unit supplies the cooling water to the cooling water inlet.

According to this mode, as in the description of the above embodiment, the cooling water can be supplied without an influence from the external environment.

### (Mode I)

In a toner manufacturing device such as the toner manufacturing device 500 including a grinder for grinding a toner material, the mechanical grinding device such as the horizontal-type mechanical grinding mill 100 according to any of Modes A to H is used as the grinder.

According to this mode, as in the description of the above embodiment, the toner manufacturing device of manufacturing toner having favorable quality can be realized.

### (Mode J)

In a toner manufacturing method including a grinding step of grinding toner, the mechanical grinding device such as the horizontal-type mechanical grinding mill 100 according to any of Modes A to H is used in the grinding step.

According to this mode, as in the description of the above embodiment, the toner manufacturing method of manufacturing toner having favorable quality can be realized.

What is claimed is:

1. A mechanical grinding device comprising:
a cylindrical stator;
a columnar rotor arranged inside the stator in such a manner that the center axis overlies the center axis of the stator, the rotor being rotatable about the center axis;
a grinding chamber formed in a gap between an inner peripheral surface of the stator and an outer peripheral surface of the rotor, the grinding chamber being configured to have an inside through which an item to be ground passes, to thereby the item to be ground is ground by rotating the rotor;
an item-to-be-ground supply port for supplying the item to be ground to the grinding chamber, the item-to-be-ground supply port being provided in one end in the axial direction parallel to the center axis in the grinding chamber;
a ground item discharge port for discharging a ground item obtained by grinding the item to be ground, the ground item discharge port being provided in the other end in the axial direction in the grinding chamber; and
a cooling water supplying unit for supplying cooling water to a cooling water flow passage provided inside the rotor, wherein
the axial direction is the horizontal direction,
a cooling water inlet from which the cooling water is brought into the cooling water flow passage is provided in the rotor on the side of the ground item discharge port in the axial direction, and
a cooling water outlet from which the cooling water comes out after passing through the cooling water flow passage is provided in the rotor on the side of the item-to-be-ground supply port in the axial direction.

2. The mechanical grinding device according to claim 1, wherein
the inner peripheral surface of the stator is formed in such a manner that a concave part and a convex part extending in parallel to the axial direction are alternately continued in the circumferential direction, and
the outer peripheral surface of the rotor is formed in such a manner that a concave part and a convex part extending in parallel to the axial direction are alternately continued in the circumferential direction.

3. The mechanical grinding device according to claim 1, wherein
the cooling water is brine containing ethylene glycol, and
a temperature of a gas discharged from the ground item discharge port together with the ground item is adjusted to be within a range from 10[° C.] or more to 35[° C.] or less by adjusting a temperature of the cooling water supplied to the cooling water inlet within a range from −20[° C.] or more to 0[° C.] or less when a grinding action is performed, and
adjusting the temperature within a range from 0[° C.] or more to 20[° C.] or less when the grinding action is not performed.

4. The mechanical grinding device according to claim 1, wherein
the rotation number of the rotor is 2,000 [rpm] or more and 5,700 [rpm] or less, and
the cooling water passes through a bearing member for supporting the rotor rotatably with respect to a casing of a device main body.

5. The mechanical grinding device according to claim 1, wherein
rotary joints corresponding to the rotation number of 5,700 [rpm] are provided in the cooling water inlet and the cooling water outlet,
a proof stress yield point of end plates arranged on the both end sides in the axial direction of the rotor is 240 [N/mm²] or more,
maximum deflection of the end plates is 1/4 or less,
each of the end plates includes an intra-end plate flow passage through which the cooling water passes,
an O ring made of an elastic body is provided in a border between the intra-end plate flow passage and the cooling water flow passage, and
rubber hardness of the O ring is Hs 90 or more.

6. The mechanical grinding device according to claim 1, wherein
the cooling water supplying unit includes a cooling water storage for storing the cooling water, and
the cooling water storage is installed to be away from the rotor by a distance in the horizontal direction of 10 [m] or less and by vertical height of 5 [m] or less.

7. The mechanical grinding device according to claim 1, further comprising:
a water content detector provided in the grinding chamber.

8. The mechanical grinding device according to claim 1, wherein
when the grinding action is not performed, the temperature of the cooling water supplied to the cooling water inlet is adjusted to be not less than 0[° C.], and
heat retention and dew proof features are provided in a supply pipe through which the cooling water supplying unit supplies the cooling water to the cooling water inlet.

9. A toner manufacturing device comprising a grinder for grinding a toner material, wherein the grinder is the mechanical grinding device according to claim 1.

10. A toner manufacturing method comprising grinding a toner material with the mechanical grinding device according to claim 1.
